(19) United States
(12) Patent Application Publication
(10) Pub. No.: US 2025/0371492 A1
(43) Pub. Date: Dec. 4, 2025

(54) INVENTORY MANAGEMENT

(71) Applicant: Honeywell International Inc., Charlotte, NC (US)

(72) Inventors: Varun Singh, PUNE (IN); Kartikeyan Bollapalli, Bangalore (IN)

(21) Appl. No.: 18/732,656

(22) Filed: Jun. 4, 2024

Related U.S. Application Data
(60) Provisional application No. 63/539,595, filed on Sep. 21, 2023.

(51) Int. Cl. G06Q 10/087; G06K 7/14

(52) U.S. Cl. CPC G06Q 10/087; G06K 7/1417

(57) ABSTRACT

Techniques for managing inventory of a product at a facility in a supply chain are described. In an example, product code information associated with the product at the facility is received, where the product code information comprises at least one of hierarchical information, path information, and event information associated with the product. An expected inventory of the product at the facility is then determined from the product code information. An actual inventory of the product at the facility is then retrieved from an inventory database associated with the facility. The expected inventory is then compared with the actual inventory to identify a discrepancy in the inventory of the product. A point of discrepancy in the supply chain where the discrepancy in the inventory of the product had occurred is then identified, where the point of discrepancy is identified from the path information.

### BACKGROUND

Products in a supply chain move through various facilities of the supply chain, such as suppliers, manufacturers, warehouses, and distributors. For a product to move from a source location to a designated destination, the product is subjected to various processes, such as commissioning, packing, shipping, decommissioning, and the like. Such movement of the product through various facilities and processes of the supply chain is usually recorded by tracking systems.

### BRIEF DESCRIPTION OF FIGURES

FIG. 1 illustrates an environment for implementing Inventory Management System (IMS) for managing inventory of products at a facility in a supply chain, in accordance with an example of the present subject matter,

FIG. 2 illustrates the environment for implementing the IMS, in accordance with another example of the present subject matter,

FIG. 3 illustrates the environment for implementing the IMS, in accordance with yet another example of the present subject matter,

FIG. 4 illustrates a schematic of the IMS, in accordance with an example of the present subject matter,

FIG. 5 illustrates the schematic of the IMS, in accordance with another example of the present subject matter,

FIG. 6 illustrates a method for managing inventory of products at the facility in the supply chain, in accordance with an example of the present subject matter,

FIG. 7 illustrates the method for managing inventory of products at the facility in the supply chain, in accordance with another example of the present subject matter,

FIG. 8 illustrates the method for managing inventory of products at the facility in the supply chain, in accordance with yet another example of the present subject matter,

FIG. 9 illustrates a method for identification of point of discrepancy in the supply chain, in accordance with examples of the present subject matter,

FIG. 10 illustrates the method for identification of point of discrepancy in the supply chain, in accordance with examples of the present subject matter,

FIG. 11 illustrates a non-transitory computer-readable medium for managing inventory of products at a facility in a supply chain, in accordance with an example of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

Products in a facility are usually transported in pallets where multiple units of a product are packed into cartons, followed by multiple cartons being packed into cases, and the multiple cases being packed into the pallets. At each facility the products are identified; and information associated with the product, such as hierarchical information uniquely identifying a carton in which the product is packed, a case in which the carton is packed, and a pallet in which the case is packed; a location of the product, a status update of the product, and number of products, is updated into a tracking system for real-time visibility of the product within the supply chain. Updating the information related to the products in such a manner helps in tracking products throughout the supply chain.

There is a possibility that the pallet, while being transported from a first facility to a second facility in the supply chain, may be compromised and a discrepancy may arise in one or more product(s) packed into the pallet. In such a situation, if the discrepancy in the one or more products is to be identified, the pallet and the cartons included in the pallet are opened, and the cases including the product are counted. Further, the hierarchical information associated with the products is utilized to derive a quantity of products received at the second facility. A count of products, determined based on the counting of the products, is then compared with the quantity of products derived based on the hierarchical information to determine a count or identification of lost products.

However, manually determining the count of products by opening the pallet and the cartons and comparing the count with the quantity of products derived using hierarchical information to identify the discrepancy is not only tedious and cumbersome but is also prone to errors. Further, while it may be possible to identify the discrepancy based on the comparison of the count of products with the derived quantity of products, such comparison does not facilitate identification of a location or time when the discrepancy occurred.

According to examples of the present subject matter, techniques for managing inventory of products at a facility in a supply chain are described.

In an example implementation, product code information associated with a product at the facility may be retrieved. The product code information may include at least one of hierarchical information, path information, and event information associated with the product. The hierarchical information indicates a hierarchy of packing of the product within a pallet, the path information indicates movement of the product across a plurality of facilities in the supply chain, and the event information indicates occurrence of an event in at least one facility from the plurality of facilities affecting a quantity of products. In an example, the product code information may conform with GS1 Electronic Product Code Information Services (EPCIS) standard. An expected inventory of the product at the facility may then be derived from the product code information.

An actual inventory of the product at the facility is then retrieved. The actual inventory is retrieved from an inventory database associated with the facility. The derived inventory is then compared with the actual inventory to identify a discrepancy in the inventory of the product. Once the discrepancy has been identified, a point of discrepancy in the supply chain is identified where the discrepancy in the inventory of the product had occurred. In an example, the point of discrepancy is identified from the path information. In another example, the point of discrepancy is identified from sensor data received from a sensor mounted onto the pallet. In yet another example, the point of discrepancy is identified from a combination of the path information and the sensor data.

Determining the derived inventory based on the product code information and comparing the derived inventory with the actual inventory at the facility facilitates automatic identification of discrepancies in the inventory at the facility, thereby ensuring accountability of one or more products corresponding to a pallet. Further, utilization of at least one of the path information and the sensor data for initiating the investigative action facilitates identification of a point where the discrepancy occurred in the supply chain.

The above aspects are further described in conjunction with the figures, and in the associated description below. It should be noted that the description and figures merely illustrate principles of the present subject matter. Therefore, various arrangements that encompass the principles of the present subject matter, although not explicitly described or shown herein, may be devised from the description and are included within its scope.

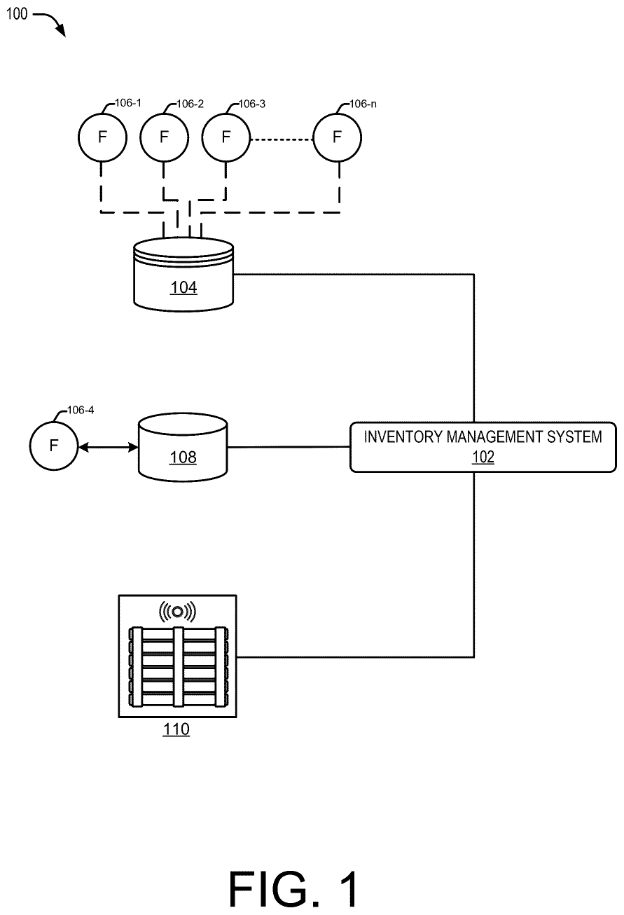

FIG. 1 illustrates an environment 100 for implementing an Inventory Management System (IMS) 102, in accordance with an example of the present subject matter. In an example, the IMS 102 may be configured to manage inventory of products at a facility in a supply chain.

The environment 100 may include a supply chain repository 104 coupled to the IMS 102. In an example, the supply chain repository 104 may include data conforming with GS1 Electronic Product Code Information Services (EPCIS) standard. The supply chain repository 104 may store product code information associated with different products at various facilities 106-1,106-2, 106-3, . . . , 106-n in the supply chain. For the ease of reference, the facilities 106-1, 106-2, 106-3, . . . , 106-n have been referred to as the facilities 106, hereinafter.

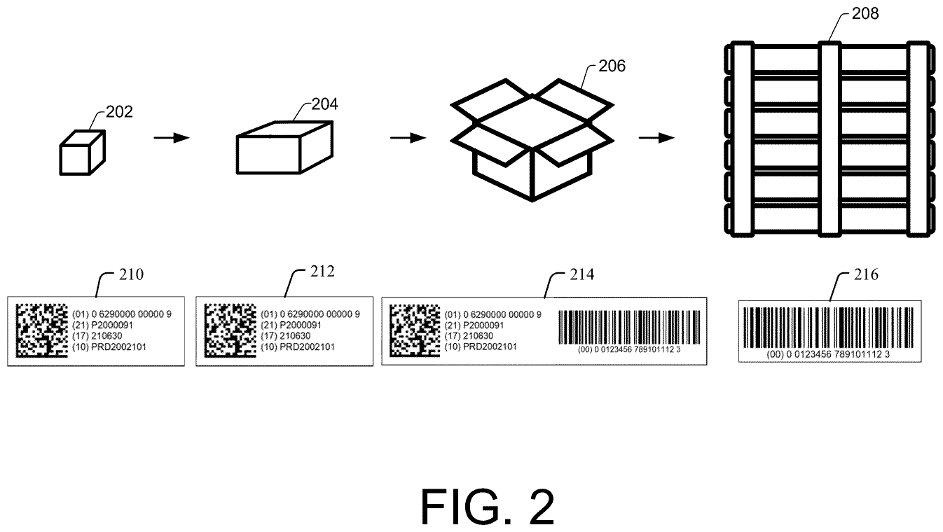

The product code information associated with a product may include hierarchical information related to a product, where the hierarchical information may indicate a hierarchy of packing the product within a pallet. As illustrated in FIG. 2, the hierarchical information 200 associated with a unit of product 202 may indicate how the product 202 is packed. For example, multiple units of the product 202 may be packed into a carton 204. Multiple cartons 204 may be packed into a case 206 and multiple cases 206 may be packed into a pallet 208. The hierarchical information 200 of the product 202 may be based on the GS1 EPCIS standard.

In an example, a product identifier 210, alternatively referred to as product_ID, may be generated for each unit of the product 202. In an example, a unit of the product 202 may be a saleable unit. The product_ID 210 may be generated for each unit of the product 202 based on the GS1 standard. Similarly, a carton_ID 212 may be generated for each carton 204 which would indicate a parent-child relationship of the multiple units of the products 202 stored in the corresponding cartons 204, a case_ID 214 may be generated for each case 206 which would indicate a parent-child relationship of the multiple units of cartons 204 stored in the corresponding case 206, and a pallet_ID 216 may be generated for each pallet 208 which would indicate a parent-child relationship of the multiple units of cases 206 stored in the corresponding pallet 208. In an example, the case_ID 214 generated for cases 206 and the pallet_ID 216 generated for the pallets may be a GS1-128 barcode or a Serial Shipping Container Code (SSCC).

The pallet_ID 216 may be indicative of the multiple cases 206 packed into the pallet 208, the case_ID 214 may be indicative of the multiple cartons 204 packed into the case 206, and the carton_ID 212 may be indicative of the multiple products 202 packed into the carton 204. Each of the product_ID 210, the carton_ID 212, the case_ID 214, and the pallet_ID 216, amongst other information, may be indicative of a serialized Global Trade Item Number (GTIN), a serial number, an expiry date, and a batch number.

In an example, on scanning the pallet_ID 216, the case_ID 214, or the carton_ID 212, information corresponding to the cases, cartons, and products may be obtained. For example, if a pallet_ID 216 of a particular pallet is scanned, information associated with all the cases, cartons, and products stored in that particular pallet may be obtained. It would be noted that while hierarchical information 200 has been discussed with respect to a unit of the product, cartons, cases, and pallets, principles of the present subject matter would be applicable to other techniques for packaging and tracking of products.

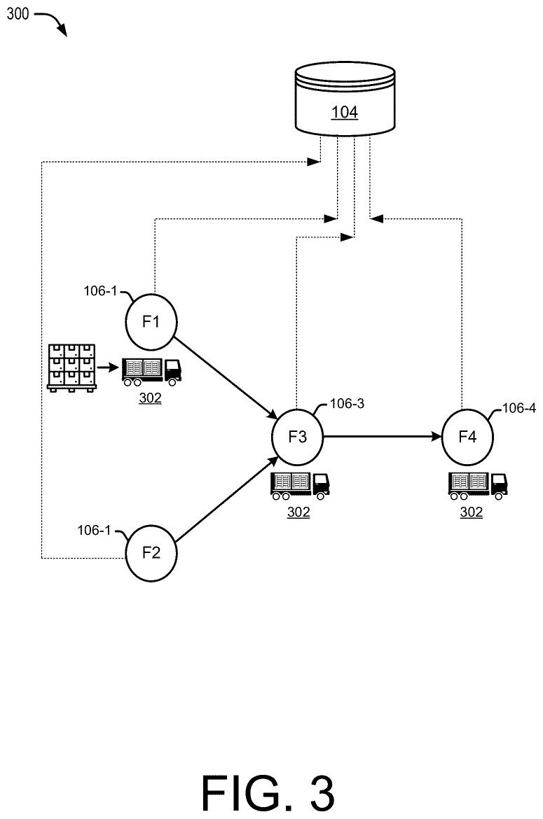

The product code information may further include a path information associated with the product, where the path information may be indicative of the movement of the product across a plurality of facilities 106 in the supply chain. As illustrated in FIG. 3, when pallets 302 including the product is transported from an assembly plant to a retail location, information associated with the movement of the pallets 302 may be uploaded to the supply chain repository 104 at every stop during the transit. For instance, when the pallets 302 are loaded onto a shipment container at the assembly plant, such as the facility 106-1, pallet_ID for each of the pallets 302 may be scanned. At this instance, an indication that the pallets 302 are leaving the assembly plant may be uploaded to the supply chain repository 104.

Thereafter, when the pallets 302 reach a distribution centre, such as the facility 106-3, the pallet_ID for the pallets 302 may be scanned at an entry gate of the distribution centre. At this instance, an indication that the pallets 302 have reached the distribution centre may be uploaded to supply chain repository 104. Thereafter, when the pallets 302 are to be transported to the retail location, the pallets 302 may be loaded onto another shipment container destined for the retail location. At this instance, an indication that the pallets 302 have left the distribution centre may be transmitted to supply chain repository 104. Further, when the pallets finally reach the retail location, such as the facility 106-4, the pallet_ID for the pallets 302 may be scanned at an entry gate of the retail location. Accordingly, an indication that the pallets 302 have reached the retail location may be sent to supply chain repository 104. In an example, the above-described indications sent to the supply chain repository 104 when the product moves through various facilities in the supply chain may be combined to generate the path information associated with the product.

The product code information may further include an event information, where the event information is indicative of events in at least one facility from the plurality of facilities 106 that may affect a quantity of the product. In an example, the event information may be indicative of the information about the products involved in an event, information about the facility or location where the event occurred, the time and date of the event, and a reason for the event.

Further, the events may include, but are not limited to, a commission event, a decommission event, an aggregation event, and a disaggregation event. The commission event may describe a new product unit being created. Further, the decommission event may describe a product unit being removed from the supply chain. For instance, the decommission event may occur when there is a product loss due to spoilage or contamination. Furthermore, the aggregation event may describe one or more product units being combined into a larger container, such as a pallet or SSCC, for shipment. Moreover, the disaggregation event may describe the separation of product units in the aggregation event.

The environment 100 may further include an inventory database 108 coupled to the IMS 102. In an example, the inventory database 108 may be associated with the facility for which the inventory is being managed, such as the facility 106-4. The inventory database 108 may store the actual inventory of products at the facility 106-4.

The environment 100 may further include different sensors 110 coupled the IMS 102. In an example, the sensors 110 may be mounted onto the pallets moving across the facilities 106 in the supply chain. Examples of the sensors 110 may include, but are not limited to, Global Positioning System (GPS) sensor, temperature sensor, gyroscope, and accelerometer.

The sensors 110 may monitor various physical parameters of the pallets, such as temperature, orientation, and vibration. In addition to the physical parameters, the sensors 110 may also monitor time-stamped location data for pallets. The sensors may accordingly generate sensor data, such as location of the pallet, temperature of the pallet, vibration characteristics of the pallet, or a combination thereof. The sensors 110 may then communicate the sensor data to the IMS 102.

In an example implementation, the IMS 102 may retrieve product code information associated with a product at the facility 106-4. The product code information may include hierarchical information, path information, and event information for the product. The hierarchical information may indicate the hierarchy of packing of the product within the pallet, the path information may indicate movement of the product across the plurality of facilities 106 in the supply chain, and the event information may indicate occurrence of an event affecting the quantity of the product in at least one facility from the plurality of facilities 106. In an example, the IMS 102 may then utilize the product code information to derive an expected inventory of the product at the facility 106-4.

The IMS 102 may then retrieve an actual inventory of the product 202 at the facility 106-4. In an example the IMS 102 may retrieve the actual inventory of the product 202 from the inventory database 108 associated with the facility 106-4. Subsequently, the IMS 102 may compare the expected inventory with the actual inventory to identify a discrepancy in the inventory of the product at the facility 106-4.

Upon identification of the discrepancy, the IMS 102 may identify a point of discrepancy in the supply chain where the discrepancy in the inventory of the product had occurred. In an example, the point of discrepancy may be identified from the path information. In another example, the point of discrepancy may be identified from the sensor data. In yet another example, the point of discrepancy may be identified based on a combination of the path information and the sensor data.

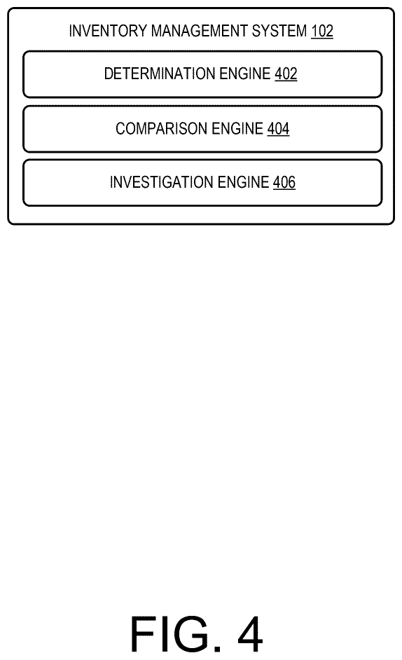

FIG. 4 illustrates a schematic of the IMS 102, in accordance with an example of the present subject matter. In an example, the IMS 102 may include a determination engine 402. The determination engine 402 may retrieve product code information associated with the product 202 at the facility 106-4. The product code information may include at least one of hierarchical information, path information, and event information associated with the product. The hierarchical information may indicate the hierarchy of packing of the product within the pallet, the path information may indicate movement of the product across a plurality of facilities 106 in the supply chain, and the event information may indicate occurrence of an event in at least one facility from the plurality of facilities that affects the quantity of the product.

Upon receiving the product code information, the determination engine 402 may determine an expected inventory of the product at the facility 106-4. For instance, the determination engine 402 may determine an expected inventory of product at the facility 106-4, taking into account the hierarchical information of how the product is packed and any event information, such as a report of damaged goods at a previous facility.

The determination engine 402 may then retrieve an actual inventory of the product 202 at the facility 106-4. In an example, the determination engine 202 may retrieve the actual inventory from the inventory database 108.

The IMS 102 may further include a comparison engine 404 coupled to the determination engine 402. In an example, the comparison engine 404 may to compare the expected inventory with the actual inventory to identify a discrepancy in the inventory of the product.

The IMS 102 may further include an investigation engine 406 coupled to the comparison engine 404. In an example, upon identification of the discrepancy, the investigation engine 406 may identify a point of discrepancy in the supply chain where the discrepancy in the inventory of the product had occurred. In an example, the point of discrepancy is identified from sensor data received from a sensor mounted onto the pallet 208.

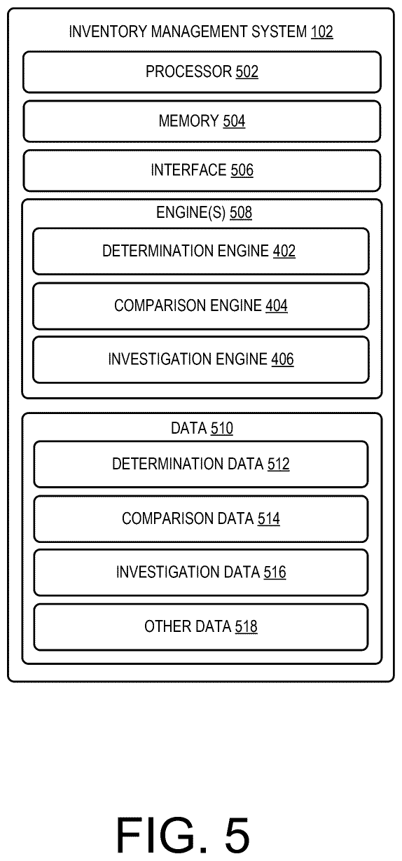

FIG. 5 illustrates the schematic of the IMS 102, in accordance with another example of the present subject matter. As illustrated, the IMS 102 may include a processor 502 and a memory 504 coupled to the processor 502. The functions of the various elements shown in the FIGs., including any functional blocks labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, conventional and/or custom, may also be included.

The memory 504 may include any computer-readable medium including, for example, volatile memory (e.g., RAM), and/or non-volatile memory (e.g., EPROM, flash memory, etc.).

The IMS 102 may further include an interface 506. The interface 506 may allow the connection or coupling of the IMS 102 with one or more other devices, through a wired (e.g., Local Area Network, i.e., LAN) connection or through a wireless connection (e.g., Bluetooth®, WiFi). The interface 506 may also enable intercommunication between different logical as well as hardware components of the IMS 102.

The IMS 102 may further include engine(s) 508, where the engine(s) 508 may include the determination engine 402, the comparison engine 404, and the investigation engine 406. In an example, the engine(s) 508 may be implemented as a combination of hardware and firmware or software. In examples described herein, such combinations of hardware and firmware may be implemented in several different ways. For example, the firmware for the engine may be processor executable instructions stored on a non-transitory machine-readable storage medium and the hardware for the engine may include a processing resource (for example, implemented as either a single processor or a combination of multiple processors), to execute such instructions.

In the present examples, the machine-readable storage medium may store instructions that, when executed by the processing resource, implement the functionalities of the engine. In such examples, the IMS 102 may include the machine-readable storage medium storing the instructions and the processing resource to execute the instructions. In other examples of the present subject matter, the machine-readable storage medium may be located at a different location but accessible to the IMS 102 and the processor 502.

The IMS 102 may further include data 510, that serves, amongst other things, as a repository for storing data that may be fetched, processed, received, or generated by the engine(s) 508. In an example, the data 510 may include the determination data 512, the comparison data 514, the investigation data 516, and the other data 518. In an example, the data 510 may be stored in the memory 504.

In an example implementation, the determination engine 402 may retrieve the product code information for a product, such as the product 202, at the facility 106-4. As already described, the product code information may include the hierarchical information indicative of the hierarchy of packing of the product 202 within the pallet 208, the path information indicative of the movement of the product 202 across a plurality of facilities 106 in the supply chain, and the event information indicative of the occurrence of an event in at least one facility from the plurality of facilities 106 that affects the quantity of the product.

In an example, the determination engine 402 may retrieve the product code information upon detecting an indication to perform inventory verification for the facility 106-4. In the example, the inventory verification may be performed when a shipment of the product is received at the facility 106-4. The inventory verification may be performed to identify any discrepancies in the inventory records, such as overstocking, stockouts, or thefts, and take a corrective action to avoid potential losses.

The determination engine 402 may then utilize the product code information to determine an expected inventory of the product at the facility. In an example, to determine the expected inventory, the determination engine 402 may identify the pallets corresponding to the product_ID for the product 202. The determination engine 402 may then derive a preliminary inventory of products based on the pallet_ID of the identified pallets.

Thereafter, the determination engine 402 may analyse the event information for the product in at least one facility from the plurality of facilities to identify the events that may have affected the quantity of products. For instance, the determination engine 402 may identify that after reception of the shipment including the product 202 at a previous facility, such as the facility 106-3, some pallets were decommissioned due to contamination or physical damage. The determination engine 402 may accordingly remove the contaminated products from the preliminary inventory and determine an expected inventory of the product 202 at the facility. The determination engine 402 may then store the expected inventory in the determination data 512.

The determination engine 402 may then retrieve an actual inventory of the product 202 at the facility 106-4. The determination engine 402 may retrieve the actual inventory from an inventory database associated with the facility 106-4. In an example, the inventory database may be populated with the actual inventory of the product 202 through an automatic scanning process. For instance, when a shipment arrives at the facility 106-4, Radio Frequency Identifier (RFID) readers installed at the gates of the facility 106-4 may read the pallet_IDs from the pallets included in the shipment and transmit the pallet_IDs to the inventory database 108. The determination engine 402 may then store the actual inventory in the determination data 512.

The comparison engine 404 may then compare the expected inventory with the actual inventory to identify a discrepancy in the inventory of the product 202. In an example, if the comparison engine 404 identifies the discrepancy in the inventory of the product 202, the comparison engine 404 may set a discrepancy flag in the comparison data 514. In such a situation, the investigation engine 406 may identify a point of discrepancy in the supply chain where the discrepancy in the inventory of the product had occurred. The investigation engine 406 may identify the point of discrepancy in the supply chain in various ways.

In an example, the investigation engine 406 may identify the point of discrepancy from the path information. In the example, upon determining presence of discrepancy, the investigation engine 406 may retrieve the pallet_IDs of the pallets that include the product. The investigation engine 406 may then extract the path information corresponding to such pallets from the product code information and analyse the movement of the product from the assembly plant to the retail location.

For instance, the investigation engine 406 may identify that ‘50’ pallets including a product initially left the assembly plant, i.e., the facility 106-1. The investigation engine 406 may further identify that the ‘50’ pallets reached the distribution centre, i.e., the facility 160-3. However, upon further analysis of the path information, the investigation engine 406 may identify that out of the ‘50’ pallets, only ‘49’ pallets were shipped out from the distribution centre. In such a situation, the investigation engine 406 may determine the point of discrepancy to be the distribution centre.

In another example, the investigation engine 406 may identify the point of discrepancy from the sensor data. In the example, upon determining presence of discrepancy, the investigation engine 406 may retrieve the pallet_IDs of the pallets that include the product. The investigation engine 406 may then retrieve the sensor data collected from the sensors mounted onto the pallets, where the sensor data is indicative of different physical parameters of the pallets, such as temperature, orientation, and vibration. In addition, the sensor data may also be indicative of the time-stamped location data of the pallets. Thereafter, the investigation engine 406 may compare the different physical parameters with their respective thresholds to identify the point of discrepancy in the supply chain.

For instance, when the product being shipped is temperature sensitive, the investigation engine 406 may identify the instances when the temperature of the pallet breached the threshold. The investigation engine 406 may then identify a location of the pallet where the temperature of the pallet breached the threshold. Such a location may be designated as the point in the supply chain where the discrepancy in the inventory of the product had occurred.

Similarly, when the product being shipped is fragile, the investigation engine 406 may identify the instances when the vibration of the pallet breached the threshold. The investigation engine 406 may then identify a location of the pallet where the vibration of the pallet breached the threshold. Such a location may be designated as the point in the supply chain where the discrepancy in the inventory of the product had occurred.

In yet another example, the investigation engine 406 may identify the point of discrepancy from a combination of the sensor data and the information. For instance, the investigation engine 406 may identify that ‘50’ pallets including the product initially left the assembly plant, i.e., the facility 106-1. The investigation engine 406 may further identify that the ‘50’ pallets reached the distribution centre, i.e., the facility 160-3. Further, the investigation engine 406 may identify that the ‘50’ pallets were subsequently shipped out of the distribution centre. However, upon further analysis of the path information, the investigation engine 406 may identify that out of the ‘50’ pallets, only ‘49’ pallets were received at the retail location. In such a situation, the investigation engine 406 may determine the point of discrepancy to be present on the path between the distribution centre and the retail location. In such a situation, the investigation engine 406 may retrieve the sensor data for the time period when the pallets were in transit between the distribution centre and the retail location. The investigation engine 406 may accordingly identify the point in the supply chain where the discrepancy in the inventory of the product had occurred.

In an illustrative example, the IMS 102 may be utilized by a pharmaceutical company for managing an inventory of vaccines at a distribution centre. In the example, the determination engine 402 may retrieve product code information for the vaccines, which includes hierarchical information including vaccine vials in cartons, cartons in cases, and cases in pallets; path information including information related to movement of the vaccine from a manufacturing facility to the distribution centre; and event information including information on quality checks and temperature monitoring events. The determination engine 402 may determine an expected inventory of vaccines at the distribution centre, taking into account the hierarchical information of how the vaccines is packed and any event information, such as a report of damaged goods at a previous facility.

The determination engine 402 may then determine the actual inventory of the products at the distribution centre from an inventory database. In an example, the distribution centre may have RFID readers installed at a receiving dock. In the example, when the vaccines arrive at the distribution centre, the RFID readers may read the pallet_ID on the pallets and automatically update the inventory database with the actual inventory of the vaccine.

The comparison engine 404 may then compare the expected inventory with the actual inventory to identify the discrepancy in the inventory of the vaccines at the facility. When the discrepancy is identified, the investigation engine may analyse at least one of the path information and sensor data from sensors mounted on the pallets. In an example, the sensor data may include time-stamped location data which indicate that the pallets made an unscheduled stop. In the example, the sensor data may also include the physical parameters of the pallets which indicate that the temperature rose above the safe threshold for vaccine storage during that time.

By correlating the time-stamped location data with the temperature excursion event, the investigation engine 406 may identify the point of discrepancy as the unscheduled stop where the vaccines may have been compromised due to improper storage conditions. Accordingly, the pharmaceutical company may quickly identify and respond to inventory discrepancies, ensuring the integrity of the vaccines and maintaining a high standard of accountability throughout the supply chain.

In another illustrative example, the IMS 102 may be utilized by an electronics manufacturer for managing an inventory of smartphones at a regional warehouse. In the example, the determination engine 402 may retrieve the product code information for the smartphone, which includes hierarchical information including smartphones in boxes, boxes in cartons, and cartons in pallets; path information related to movement of the smartphones from an assembly plant to the regional warehouse; and event information, such as customs clearance and security checks. The determination engine 402 may then use the hierarchical and event information to derive the expected inventory of smartphones at the regional warehouse, taking into account known issues reported at earlier stages, such as a batch of smartphones being held back at customs for additional inspection.

The determination engine 402 may then derive the actual inventory of smartphones at the warehouse using an automated scanning process. In an example, RFID readers at the warehouse gates may scan the pallet_ID on the pallets and automatically populate the inventory database with the actual count of smartphone cartons.

The comparison engine 404 may then compare the expected inventory with the actual inventory to identify the discrepancy in the inventory of smartphones. In an example, the comparison engine 404 may identify that there are fewer smartphones in the actual inventory than expected. In the example, the investigation engine 406 may examines the path information and sensor data from sensors attached to the pallets. In an example, the sensor data may include time-stamped location data, which reveals that the pallets were rerouted due to a logistics error. In the example, the sensor data may further include the physical parameters of the pallets which indicate that the pallets were exposed to high humidity levels during the reroute.

By analysing the time-stamped location data in conjunction with the physical parameters and the rerouting event, the system identifies the point of discrepancy as the reroute, where the smartphones may have been exposed to potential damage from humidity. Accordingly, the electronics manufacturer may swiftly pinpoint and address inventory discrepancies, ensuring that the products meet quality standards and that the supply chain operates with transparency and efficiency.

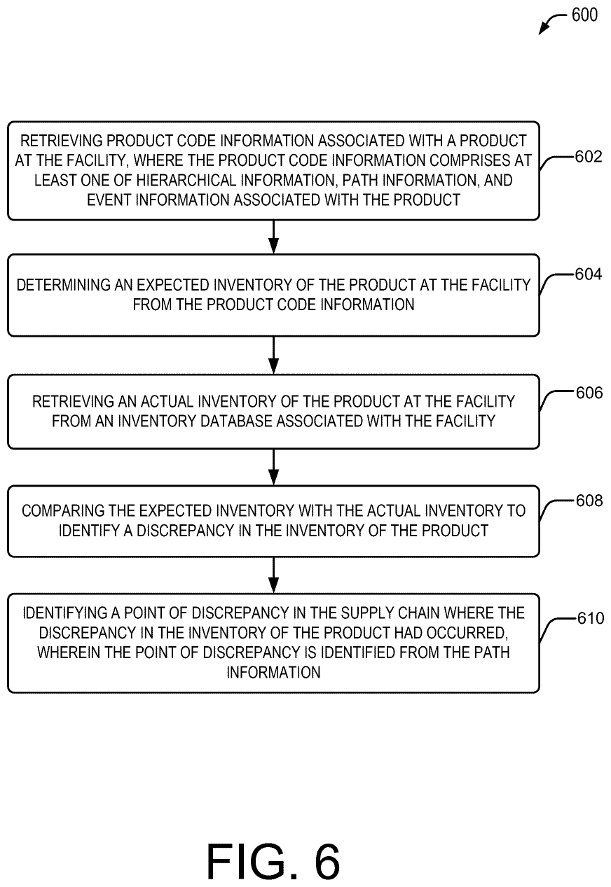

FIGS. 6, 7, and 8 illustrate methods 600, 700, and 800 for managing inventory of products at a facility in a supply chain, in accordance with an example of the present subject matter. The order in which the methods are described is not intended to be construed as a limitation, and any number of the described method blocks may be combined in any order to implement the methods, or an alternative method. Further, the methods 600, 700, and 800 may be implemented by processing resources or computing device(s) through any suitable hardware, non-transitory machine-readable instructions, or combination thereof.

It may also be understood that methods 600, 700, and 800 may be performed by programmed computing devices, such as the IMS 102. Furthermore, the methods 600, 700, and 800 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 600, 700, and 800 are described below with reference to the IMS 102, as described above; other suitable systems for the execution of these methods may also be utilized. Additionally, implementation of the method is not limited to such examples.

In FIG. 6, at block 602, product code information associated with a product at the facility is retrieved. In an example, the product code information includes at least one of hierarchical information, path information, and event information associated with the product. Further, the hierarchical information indicates a hierarchy of packing of the product within a pallet, the path information indicates movement of the product across a plurality of facilities in the supply chain, and event information indicates occurrence of an event in at least one facility from the plurality of facilities affecting a quantity of product. The product code information may conform with GS1 EPCIS standard.

In an example, the hierarchical information may include a pallet_ID associated with a pallet, wherein the pallet_ID is indicative of case_ID associated with the case within the pallet, carton_ID associated with the carton within the case, and product_ID associated with the product within the carton. In the example, the product code information may conform with GS1 EPCIS standard. The product code information may be retrieved by the determination engine 402.

At block 604, an expected inventory of the product at the facility is determined. In an example, the expected inventory is determined from the product code information. In the example, the expected inventory may be determined based on the hierarchical information and the event information. For instance, the expected inventory may be determined by taking into account the hierarchical information of how the product is packed and event information, such as a report of damaged goods at a previous facility. In an example, the expected inventory of the product may be determined by the determination engine 402.

At block 606, an actual inventory of the product at the facility is retrieved from an inventory database associated with the facility. In an example, the actual inventory of the product at the facility may be retrieved by the comparison engine 404.

At block 608, the expected inventory may be compared with the actual inventory to identify a discrepancy in the inventory of the product. In an example, the discrepancy in the inventory of the product may be identified by the comparison engine 404.

At block 610, a point of discrepancy in the supply chain where the discrepancy in the inventory of the product had occurred is identified. In an example, the point of discrepancy is identified from the path information. In an example, the point of discrepancy in the supply chain may be identified by the investigation engine 406.

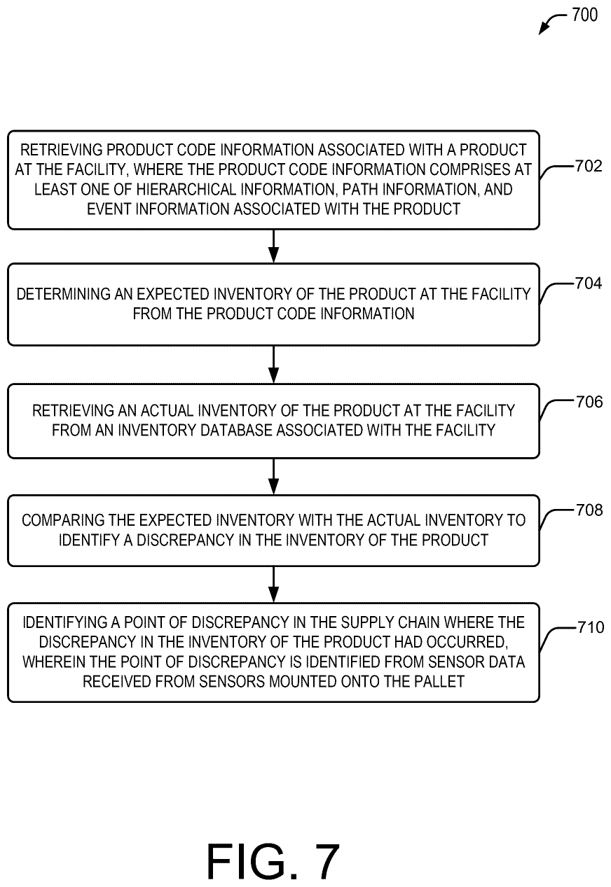

In FIG. 7, at block 702, product code information associated with a product at the facility is retrieved. In an example, the product code information includes at least one of hierarchical information, path information, and event information associated with the product. Further, the hierarchical information indicates a hierarchy of packing of the product within a pallet, the path information indicates movement of the product across a plurality of facilities in the supply chain, and event information indicates occurrence of an event in at least one facility from the plurality of facilities affecting a quantity of product. In an example, the product code information may be retrieved by the determination engine 402.

At block 704, an expected inventory of the product at the facility is determined. In an example, the expected inventory is determined from the product code information. In the example, the expected inventory may be determined based on the hierarchical information and the event information. For instance, the expected inventory may be determined by taking into account the hierarchical information of how the product is packed and event information, such as a report of damaged goods at a previous facility. In an example, the expected inventory of the product may be determined by the determination engine 402.

At block 706, an actual inventory of the product at the facility is retrieved from an inventory database associated with the facility. In an example, the actual inventory of the product at the facility may be retrieved by the comparison engine 404.

At block 708, the expected inventory may be compared with the actual inventory to identify a discrepancy in the inventory of the product. In an example, the discrepancy in the inventory of the product may be identified by the comparison engine 404.

At block 710, a point of discrepancy in the supply chain where the discrepancy in the inventory of the product had occurred is identified. In an example, the point of discrepancy is identified from sensor data received from a sensor mounted onto the pallet. The sensor data may include location of a pallet of the unit of product, temperature of the pallet, vibration characteristics of the pallet, or a combination thereof. In an example, the point of discrepancy in the supply chain may be identified by the investigation engine 406.

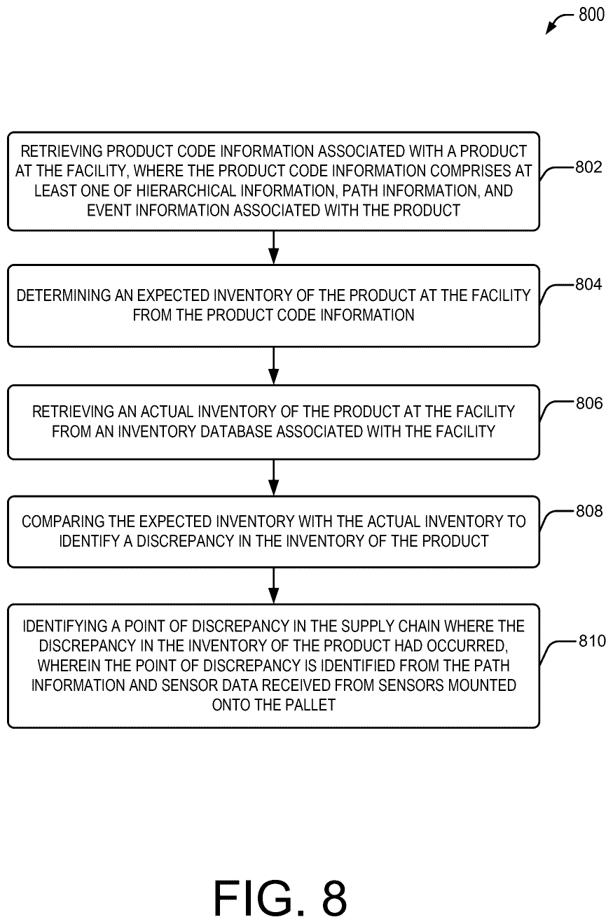

In FIG. 8, at block 802, product code information associated with a product at the facility is retrieved. The product code information includes at least one of hierarchical information, path information, and event information associated with the product. Further, the hierarchical information indicates a hierarchy of packing of the product within a pallet, the path information indicates movement of the product across a plurality of facilities in the supply chain, and event information indicates occurrence of an event in at least one facility from the plurality of facilities affecting a quantity of product. The product code information may conform with GS1 EPCIS standard. In an example, the product code information may be retrieved by the determination engine 402.

At block 804, an expected inventory of the product at the facility is determined. In an example, the expected inventory is determined from the product code information. In the example, the expected inventory may be determined based on the hierarchical information and the event information. For instance, the expected inventory may be determined by taking into account the hierarchical information of how the product is packed and event information, such as a report of damaged goods at a previous facility. In an example, the expected inventory of the product may be determined by the determination engine 402.

At block 806, an actual inventory of the product at the facility is retrieved from an inventory database associated with the facility. In an example, the actual inventory of the product at the facility may be retrieved by the comparison engine 404.

At block 808, the expected inventory may be compared with the actual inventory to identify a discrepancy in the inventory of the product. In an example, the discrepancy in the inventory of the product may be identified by the comparison engine 404.

At block 810, a point of discrepancy in the supply chain where the discrepancy in the inventory of the product had occurred is identified. In an example, the point of discrepancy is identified based on the path information and sensor data received from a sensor mounted onto the pallet. In an example, the point of discrepancy in the supply chain may be identified by the investigation engine 406.

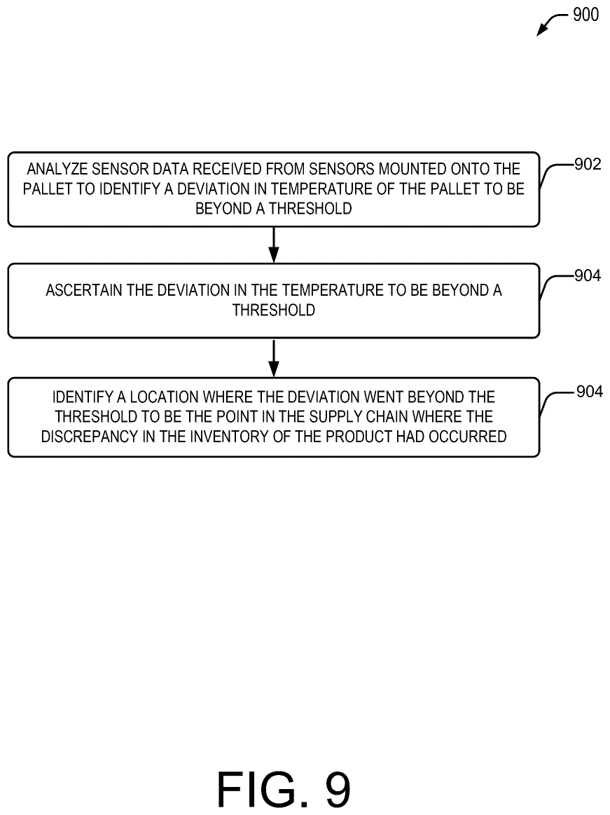

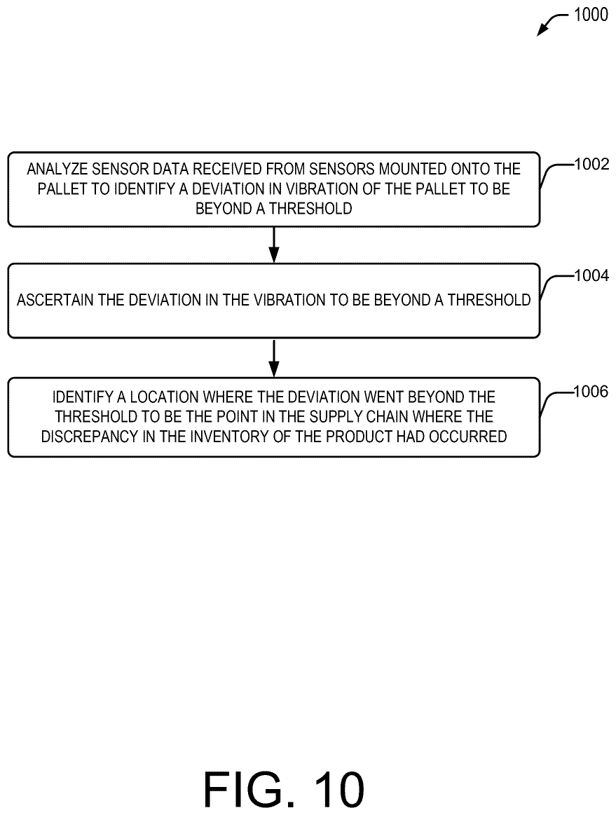

FIGS. 9 and 10 illustrate methods 900 and 1000 for identification of point of discrepancy in the supply chain, in accordance with examples of the present subject matter. The order in which the methods are described is not intended to be construed as a limitation, and any number of the described method blocks may be combined in any order to implement the methods, or an alternative method. Further, the methods 900 and 1000 may be implemented by processing resources or computing device(s) through any suitable hardware, non-transitory machine-readable instructions, or combination thereof.

It may also be understood that methods 900 and 1000 may be performed by programmed computing devices, such as the IMS 102. Furthermore, the methods 900 and 1000 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 900 and 1000 are described below with reference to the IMS 102, as described above; other suitable systems for the execution of these methods may also be utilized. Additionally, implementation of the method is not limited to such examples.

In FIG. 9, at block 902, sensor data received from a sensor mounted onto a pallet is analysed to identify a deviation in temperature of the pallet. In an example, the sensor data may be analysed by the investigation engine 406.

At block 904, the deviation in the temperature is ascertained to be beyond a threshold. In an example, the deviation in temperature may be ascertained to be beyond the threshold by the investigation engine 406.

At block 906, a location where the deviation went beyond the threshold is identified to be the point in the supply chain where the discrepancy in the inventory of the product had occurred. In an example, the location where the deviation went beyond the threshold may be identified to be the point where the discrepancy in the inventory of the product had occurred by the investigation engine 406.

In FIG. 10, at block 1002, sensor data received from a sensor mounted onto a pallet is analysed to identify a deviation in vibration of the pallet. In an example, the sensor data may be analysed by the investigation engine 406.

At block 1004, the deviation in the vibration is ascertained to be beyond a threshold. In an example, the deviation in vibration may be ascertained to be beyond the threshold by the investigation engine 406.

At block 1006, a location where the deviation went beyond the threshold is identified to be the point in the supply chain where the discrepancy in the inventory of the product had occurred. In an example, the location where the deviation went beyond the threshold may be identified to be the point where the discrepancy in the inventory of the product had occurred by the investigation engine 406.

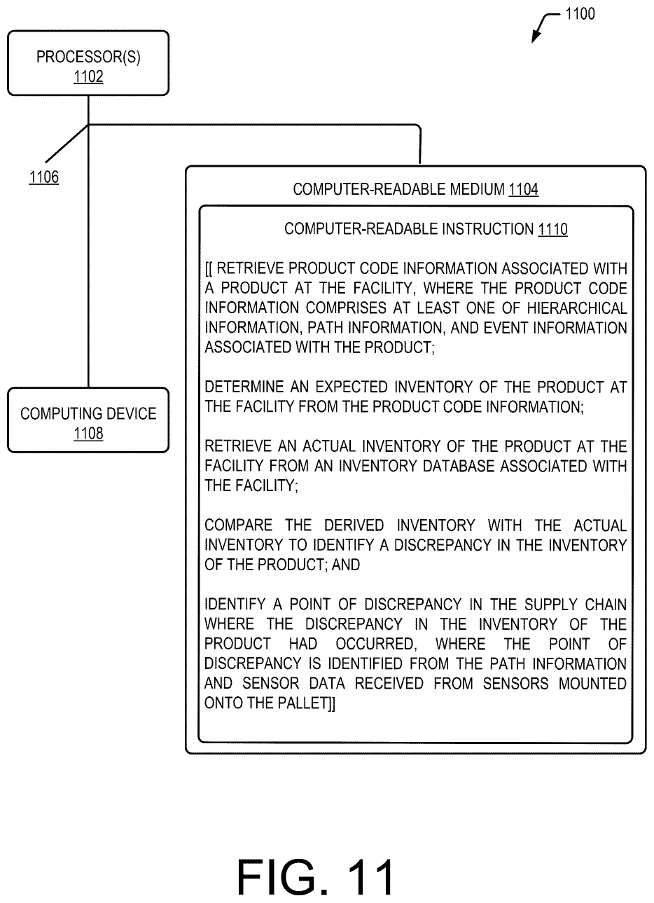

FIG. 11 illustrates a non-transitory computer-readable medium for managing inventory of products at a facility in a supply chain, in accordance with an example of the present subject matter.

In an example, the computing environment 1100 includes processor 1102 communicatively coupled to a non-transitory computer readable medium 1104 through communication link 1106. In an example implementation, the computing environment 1100 may be for example, the IMS 102. In an example, the processor 1102 may have one or more processing resources for fetching and executing computer-readable instructions from the non-transitory computer readable medium 1104. The processor 1102 and the non-transitory computer readable medium 1104 may be implemented, for example, in the IMS 102.

The non-transitory computer readable medium 1104 may be, for example, an internal memory device or an external memory. In an example implementation, the communication link 1106 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer readable medium 1104 includes a set of computer readable instructions 1110 which may be accessed by the processor 1102 through the communication link 1106 and subsequently executed for managing the inventory of products at the facility. The processor(s) 1102 and the non-transitory computer readable medium 1104 may also be communicatively coupled to a computing device 1108 over the network.

Referring to FIG. 11 in an example, the non-transitory computer readable medium 1104 includes computer readable instructions 1110 that cause the processor 1102 to retrieve product code information associated with the product at the facility. The product code information comprises at least one of hierarchical information, path information, and event information associated with the product. In an example, the hierarchical information indicates a hierarchy of packing of the product within a pallet, the path information indicates movement of the product across a plurality of facilities in the supply chain, and the event information indicates occurrence of an event in at least one facility from the plurality of facilities affecting a quantity of the product.

The instructions 1110 may then cause the processor 1102 to determine an expected inventory of the product at the facility from product code information. In an example, the instructions 1110 may cause the processor 1102 to determine the expected inventory based on the hierarchical information and the event information. For instance, the instructions 1110 may cause the processor 1102 to determine the expected inventory by taking into account the hierarchical information of how the product is packed and event information, such as a report of damaged goods at a previous facility.

The instructions 1110 may then cause the processor 1102 to retrieve an actual inventory of the product at the facility from an inventory database associated with the facility. Thereafter, the instructions 1110 may then cause the processor 1102 to compare the derived inventory with the actual inventory to identify a discrepancy in the inventory of the product.

If it is determined that there exists a discrepancy in the inventory of the product, the instructions 1110 may then cause the processor 1102 to identify a point of discrepancy in the supply chain where the discrepancy in the inventory of the product had occurred. In an example, the instructions 1110 may then cause the processor 1102 to identify the the point of discrepancy from the path information and sensor data received from sensors mounted onto the pallet.

In an example, to identify the the point of discrepancy, the instructions 1110 may cause the processor 1102 to identify a deviation in temperature of the pallet. The instructions 1110 may then cause the processor 1102 to determine the deviation to be beyond a threshold. Subsequently, the instructions 1110 may cause the processor 1102 to identify a location where the deviation went beyond the threshold to be the point in the supply chain where the discrepancy in the inventory of the product had occurred.

In another example, to identify the the point of discrepancy, the instructions 1110 may cause the processor 1102 to identify a deviation in vibration of the pallet. The instructions 1110 may then cause the processor 1102 to determine the deviation to be beyond a threshold. Subsequently, the instructions 1110 may cause the processor 1102 to identify a location where the deviation went beyond the threshold to be the point in the supply chain where the discrepancy in the inventory of the product had occurred.

Although examples of the present subject matter have been described in language specific to methods and/or structural features, it is to be understood that the present subject matter is not limited to the specific methods or features described. Rather, the methods and specific features are disclosed and explained as examples of the present subject matter.

We claim:

1. A method for managing inventory of a product at a facility in a supply chain, the method comprising:
retrieving product code information associated with a product at the facility, wherein the product code information comprises at least one of hierarchical information, path information, and event information associated with the product, wherein:
the hierarchical information indicates a hierarchy of packing of the product within a pallet,
the path information indicates movement of the product across a plurality of facilities in the supply chain, and
the event information indicates occurrence of an event in at least one facility from the plurality of facilities affecting a quantity of the product;
determining an expected inventory of the product at the facility from the product code information;
retrieving an actual inventory of the product at the facility from an inventory database associated with the facility;
comparing the expected inventory with the actual inventory to identify a discrepancy in the inventory of the product; and
identifying a point of discrepancy in the supply chain where the discrepancy in the inventory of the product had occurred, wherein the point of discrepancy is identified from the path information.

2. The method of claim 1, wherein the point of discrepancy is further identified from sensor data received from a sensor mounted onto the pallet.

3. The method of claim 1, wherein the product code information conforms with GS1 Electronic Product Code Information Services (EPCIS) standard.

4. The method of claim 1, wherein the hierarchical information comprises a pallet_ID associated with a pallet, wherein the pallet_ID is indicative of case_ID associated with the case within the pallet, carton_ID associated with the carton within the case, and product_ID associated with the product within the carton.

5. The method of claim 2, wherein the sensor data comprises location of the pallet, temperature of the pallet, vibration of the pallet, or a combination thereof.

6. The method of claim 5, wherein when the sensor data is the temperature of the pallet, identifying the point of discrepancy comprises:
identifying a deviation in the temperature of the pallet to be beyond a threshold;
identifying a location where the deviation went beyond the threshold to be the point in the supply chain where the discrepancy in the inventory of the product had occurred.

7. The method of claim 5, wherein when the sensor data is the vibration of the pallet, identifying the point of discrepancy comprises:
identifying a deviation in vibration of the pallet be beyond a threshold;
identifying a location where the deviation went beyond the threshold to be the point in the supply chain where the discrepancy in the inventory of the product had occurred.

8. An inventory management system for managing inventory of products at a facility in a supply chain, the inventory management system comprising:
a determination engine configured to:
retrieve product code information associated with a product at the facility, wherein the product code information comprises at least one of hierarchical information, path information, and event information associated with the product, wherein:
the hierarchical information indicates a hierarchy of packing of the product within a pallet,
the path information indicates movement of the product across a plurality of facilities in the supply chain, and
the event information indicates occurrence of an event in at least one facility from the plurality of facilities affecting a quantity of the product;
determine an expected inventory of the product at the facility from the product code information; and
retrieve an actual inventory of the product at the facility from an inventory database associated with the facility;
a comparison engine coupled to the determination engine configured to compare the expected inventory with the actual inventory to identify a discrepancy in the inventory of the product; and
an investigation engine coupled to the comparison engine configured to identify a point of discrepancy in the supply chain where the discrepancy in the inventory of the product had occurred, wherein the point of discrepancy is identified from sensor data received from sensors mounted onto the pallet.

9. The inventory management system of claim 8, wherein the investigation engine is to identify the point of discrepancy from the path information.

10. The inventory management system of claim 8, wherein the product code information conforms with GS1 Electronic Product Code Information Services (EPCIS) standard.

11. The inventory management system of claim 8, wherein the hierarchical information comprises a pallet_ID associated with the pallet, wherein the pallet_ID is indicative of case_ID associated with the case within the pallet, carton_ID associated with the carton within the case, and product_ID associated with the product within the carton.

12. The inventory management system of claim 8, wherein the sensor data comprises location of the pallet, temperature of the pallet, vibration of the pallet, or a combination thereof.

13. The inventory management system of claim 12, wherein when the sensor data is the temperature of the pallet, the investigation engine is to:
identify a deviation in temperature of the pallet to be beyond a threshold;
identify a location where the deviation went beyond the threshold to be the point in the supply chain where the discrepancy in the inventory of the product had occurred.

14. The inventory management system of claim 12, wherein when the sensor data is the vibration of the pallet, the investigation engine is to:
identify a deviation in vibration of the pallet be beyond a threshold;
identify a location where the deviation went beyond the threshold to be the point in the supply chain where the discrepancy in the inventory of the product had occurred.

15. A non-transitory computer readable medium comprising computer- readable instructions that when executed cause a processing resource of a computing device to:
retrieve product code information associated with a product at the facility, wherein the product code information comprises at least one of hierarchical information, path information, and event information associated with the product, wherein:
the hierarchical information indicates a hierarchy of packing of the product within a pallet,
the path information indicates movement of the product across a plurality of facilities in the supply chain, and
the event information indicates occurrence of an event in at least one facility from the plurality of facilities affecting a quantity of the product;
determine an expected inventory of the product at the facility from the product code information;
retrieve an actual inventory of the product at the facility from an inventory database associated with the facility;
compare the derived inventory with the actual inventory to identify a discrepancy in the inventory of the product; and
identify a point of discrepancy in the supply chain where the discrepancy in the inventory of the product had occurred, wherein the point of discrepancy is identified from the path information and sensor data received from sensors mounted onto the pallet.

16. The non-transitory computer-readable medium of claim 15, wherein the product code information conforms with GS1 Electronic Product Code Information Services (EPCIS) standard.

17. The non-transitory computer-readable medium of claim 15, wherein the hierarchical information comprises a pallet_ID associated with the pallet, wherein the pallet_ID is indicative of case_ID associated with the case within the pallet, carton_ID associated with the carton within the case, and product_ID associated with the product within the carton.

18. The non-transitory computer-readable medium of claim 15, wherein the sensor data comprises location of the pallet, temperature of the pallet, vibration of the pallet, or a combination thereof.

19. The non-transitory computer-readable medium of claim 18, wherein the instructions cause the processing resource to:
identify a deviation in temperature of the pallet to be beyond a threshold;
identify a location where the deviation went beyond the threshold to be the point in the supply chain where the discrepancy in the inventory of the product had occurred.

20. The non-transitory computer-readable medium of claim 18, wherein the instructions cause the processing resource to:
identify a deviation in vibration of the pallet to be beyond a threshold;
identify a location where the deviation went beyond the threshold to be the point in the supply chain where the discrepancy in the inventory of the product had occurred.
